(19) United States
(12) Patent Application Publication
(10) Pub. No.: US 2022/0331857 A1
(43) Pub. Date: Oct. 20, 2022

(54) IRON-BASED ALLOY POWDER CONTAINING NON-SPHERICAL PARTICLES

(71) Applicants: BASF SE, Ludwigshafen am Rhein (DE); Formetrix, Inc., Mansfield, MA (US)

(72) Inventors: Rudolf SEILER, Ludwigshafen (DE); Cecile MUELLER-WEITZEL, Ludwigshafen (DE); Matthias Johannes WAGNER, Ludwigshafen (DE); Rene ARBTER, Ludwigshafen (DE); Thorsten MArtin STAUDT, Ludwigshafen (DE); Marie-Claire HERMANT, Ludwigshafen (DE); Harald LEMKE, Mansfield, MA (US); Jonathan TRENKLE, Mansfield, MA (US)

(21) Appl. No.: 17/640,808

(22) PCT Filed: Sep. 3, 2020
(86) PCT No.: PCT/EP2020/074676

§ 371 Date: Mar. 5, 2022

(30) Foreign Application Priority Data
Sep. 6, 2019 (EP) 19195913.9

(51) Int. Cl. B22F 1/052; B22F 10/28; B22F 9/08

(52) U.S. Cl. CPC B22F 1/052; B22F 10/28; B22F 9/082; B22F 2301/35; B22F 2009/0844; B22F 2304/10; B22F 2009/088; B22F 2009/0828

(57) ABSTRACT

The present invention relates to an iron-based alloy powder containing non-spherical particles wherein the alloy comprises the elements Fe (iron), Cr (chrome) and Mo (molybdenum), and at least 40% of the total amount of particles have a non-spherical shape. In said iron-based alloy powder, Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.20 wt. %, the balance up to 100 wt. % is Fe.

The present invention relates to an iron-based alloy powder containing non-spherical particles wherein the alloy comprises the elements Fe (iron), Cr (chrome) and Mo (molybdenum), and at least 40% of the total amount of particles have a non-spherical shape. In said iron-based alloy powder, Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.20 wt. %, the balance up to 100 wt. % is Fe.

The invention further relates to a process for producing such an iron-based alloy powder as well as to the use of said iron-based alloy powder within a tree-dimensional (3D) printing process. A process for producing a 3D object obtained by employing the inventive iron-based alloy powder as well as the 3D object as such are further subjects of the present invention.

3D printing processes as such are very well known in the state of the art. In the field of 3D printing, various different methods/techniques of individual 3D printing processes are known, for example such as selective laser melting (SLM), electron beam melting (EBM), selective laser sintering (SLS), stereolithography or fused deposition modelling (FDM), the latter is also known as fused filament fabrication process (FFF). The individual 3D printing techniques have in common that a suitable starting material is built up layer by layer in order to form the respective three-dimensional (3D) object as such or at least a part thereof. However, the individual 3D printing techniques differ in respect of the individual starting materials employed and/or the respective individual process conditions to be employed in order to built up the desired 3D object from the respective starting material (such as the use of specific laser, electron beams or specific melting/extrusion techniques).

A task often encountered in recent times is the production of prototypes and models of metallic or ceramic bodies, in particular of prototypes and models exhibiting complex geometries. Especially for the production of prototypes, a rapid production process is necessary. For this so called “rapid prototyping”, different processes are known. One of the most economical is the fused filament fabrication process (FFF), also known as “fused deposition modeling” (FDM).

The fused filament fabrication process (FFF) is an additive manufacturing technology. A three-dimensional object is produced by extruding a thermoplastic material through a nozzle to form layers as the thermoplastic material hardens after extrusion. The nozzle is heated to heat the thermoplastic material past its melting and/or glass transition temperature and is then deposited by the extrusion head on a base to form the three-dimensional object in a layer-wise fashion. The thermoplastic material is typically selected and its temperature is controlled so that it solidifies substantially immediately upon extrusion or dispensing onto the base with the build-up of multiple layers to form the desired three-dimensional object.

In order to form each layer, drive motors are provided to move the base and/or the extrusion nozzle (dispending head) relative to each other in a predetermined pattern along the x-, y- and z-axis. The FFF-process was first described in U.S. Pat. No. 5,121,329.

WO 2019/025471 discloses a nozzle containing at least one static mixing element, wherein the nozzle and the at least one static mixing element are produced as a single-component object by a selective laser melting (SLM) process. Within this document it is described in detail how the SLM technique can be carried out. It is further disclosed therein that the respective nozzle obtained by a SLM 3D process can be employed for producing a three-dimensional green body by a FFF/FDM 3D printing technique.

WO 2018/085332 relates to alloy compositions for 3D metal printing procedures which provide metallic parts with high hardness, tensile strength, yield strength and elongation. The alloy includes as mandatory elements Fe, Cr, Mo and at least three or more elements selected from C, Ni, Cu, Nb, Si and N. The 3D printing process according to WO 2018/085332 is described therein as powder bed fusion (PBF), which can either be carried out as a selective laser melting (SLM) or as an electron beam melting (EBM) process. However, WO 2018/085332 does not contain any specific disclosure in respect of the specific shape of the alloy particles nor any specific disclosure in respect of the employed method for producing said alloy particles.

U.S. Pat. No. 4,624,409 relates to a method and an apparatus for finely dividing a molten metal by atomization. The apparatus includes a nozzle for feeding a molten metal and an annular atomizing nozzle to force a high-pressure liquid jet against a stream of the molten metal flowing from the feed nozzle. The atomizing nozzle is made of an annular jetting zone adapted to form a narrow opening under the pressure of the high-pressure liquid, an inside jacket and an outside jacket adjacent to the annular jetting zone. The respective method for obtaining finely divided molten metal by atomizations contains the step of jetting the high-pressure liquid under a jetting pressure of approximately 100 to 600 bar.

Therefore, the object underlying the present invention is to provide a new alloy powder, preferably the respective alloy powder should be employed within 3D printing processes such as the SLM technique.

According to the present invention, the object is achieved by an iron-based alloy powder containing non-spherical particles wherein the alloy comprises the elements Fe, Cr and Mo, and at least 40% of the total amount of particles have a non-spherical shape, wherein Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.20 wt. %, the balance up to 100 wt. % is Fe.

It has surprisingly been found that the iron-based alloy powder according to the present invention having a non-spherical shape has a comparable or in some cases even a better performance in terms of flowability compared to corresponding alloy powder predominantly based on particles having a spherical shape. The iron-based alloy powder according to the present invention can be successfully employed within any 3D-printing process technique, in particular within a SLM-printing process.

The iron-based alloy powder according to the present invention shows a free flowing behavior. The respective powder exhibits a good processability and/or decent build rates. Furthermore, 3D objects printed with the respective iron-based alloy powder according to the present invention exhibit high densities and/or can be characterized as having a highly dispersed fine grained microstructures and/or showing high hardness.

Furthermore, the iron-based alloy powders according to the present invention usually show a rather low amount of hollow particles. In preferred embodiments of the present invention, the particle size distribution of the respective iron-based alloy powders according to the present invention is well-suited for the processability within the SLM-technique since the particles may have a d10-value of approximately 15 μm and a d90-value of approximately 65 μm (in each case in relation to volume).

Another advantage can be seen in the fact that the iron-based alloy powder according to the present invention can be distributed in a very homogeneous way in order to form the respective layer when being employed within the respective 3D-printing process, in particular within the SLM-technique. Due to the rather broad particle size distribution, the bulk density of the respective layer is improved/higher compared to particles according to the prior art. By consequence, the shrinkage behavior of the respective layer during the 3D-printing process is reduced causing improved mechanical features, especially in the “as printed” stage (without performing any further heat treatment step). Improved mechanical features can also be seen in respect of the hardness and/or elongation at break.

The above mentioned advantages can be even further improved within some embodiments of the present invention in case the iron-based alloy powder is prepared by a process, wherein the atomization step is carried out as an ultra-high pressure liquid atomization with higher water pressures, preferably with a water pressure of at least 300 bar, more preferably of at least 600 bar. Further advantages can also be seen in higher space-time yield and/or lower process costs, especially within the latter embodiments.

Within the context of the present invention the term “non-spherical shape” or “particles having a non-spherical shape” means that the sphericity of the respective particle is not more than 0.9. The sphericity of a particle is defined as the ratio of the surface area of a sphere (with the same volume as the given particle) to the surface area of the particle. By contrast, a particle is considered as having a spherical shape in case its sphericity is more than 0.9. The sphericity of a particle can be determined by methods known to a skilled person. A suitable test method is, for example, an optical test method by particle characterizing systems (e.g. Camsizer®).

In a preferred embodiment, the sphericity (SPHT) is determined according to ISO 9276-6, wherein the sphericity (SPHT) is defined by formula (I)

$$S P H T = \frac{4 π A}{{p}^{2}} = C i r c u l a r i t {y}^{2} \qquad ( I )$$

wherein

p is the measured perimeter/circumference of a particle projection and A is the measured area covered by a particle projection. The proportion of non-spherical particles is defined as the proportion of particles whose sphericity is not more than 0.9, based on volume (Q3(SPHT)).

The invention is specified in more detail as follows.

A first subject matter according to the present invention is an iron-based alloy powder containing non-spherical particles wherein the alloy comprises the elements Fe, Cr and Mo, and at least 40% of the total amount of particles has a non-spherical shape, wherein Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.20 wt. %, the balance up to 100 wt. % is Fe.

Metal-based alloy powders as such including iron-based alloy powders are known to a person skilled in the art. This also applies to process for the production of such iron-based alloy powders as well as the specific shape of such alloy powders (for example in form of particles). The iron-based alloy powders according to the present invention comprise as mandatory (metal) elements Fe (iron), Cr (chrome) and Mo (molybdenum). Besides these three mandatory elements, the iron-based alloy powders according to the present invention may comprise further elements such as C (carbon), Ni (nickel), S (sulfur), O (oxygen), Nb (niobium), Si (silicon), Cu (copper) or N (nitrogen).

The inventive iron-based alloy powder comprises the elements as follows:

Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.25 wt. %, the balance up to 100 wt. % is Fe.

It is also preferred, that the iron-based alloy powder according to the present invention is an alloy which indicates a tensile strength of at least 1000 MPa, an elongation of at least 1.0% and a hardness (HV) of at least 450.

In another embodiment, it is preferred that the iron-based alloy powder according to the present invention is an alloy which indicates a tensile strength of at least 1000 MPa, an elongation of at least 0.5% and a hardness (HV) of at least 450.

The iron-based alloy powder according to the present invention contains non-spherical particles. At least 40% of the total amount of particles have a non-spherical shape. Besides non-spherical particles, the iron-based alloy powder may also contain particles having a spherical shape. However, it is preferred that the iron-based alloy powder according to the present invention contains more particles having a non-spherical shape than particles having a spherical shape.

In a first embodiment of the present invention it is preferred that the iron-based powder is a powder containing particles, wherein at least 50%, preferably at least 70%, more preferably at least 95%, most preferably at least 99% of the total amount of particles have a non-spherical shape.

In another preferred embodiment of the present invention, the iron-based alloy powder contains particles, wherein the total amount of particles having a non-spherical shape is in the range of at least 40 to 70%, more preferably in the range of more than 45 to 60%, most preferably in the range of at least 50 to 55%.

In another preferred embodiment of the present invention, the iron-based alloy powder contains particles, wherein the total amount of particles having a non-spherical shape is in the range of at least 40 to 70%, more preferably in the range of more than 45 to 65%, most preferably in the range of at least 50 to 60%.

The particles of the iron-based alloy powders according to the present invention are not limited to a specific diameter. However, it is preferred that the particles have a diameter in the range of 1 to 200 microns, more preferably from 3 to 70 microns, and most preferably from 15 to 53 microns.

It is also preferred that the particles of the iron-based alloy powder according to the present invention have a particle size distribution with a d10-value of at least 15 microns and a d90-value of not more than 65 microns, preferably related on a volume based Q₃-distribution.

In one embodiment of the present invention it is preferred, that the iron-based alloy powders as such are obtainable by a process, wherein the iron-based alloy powder is provided in a molten state and an atomization step is carried out with a stream of the molten iron-based alloy powder.

Within this embodiment of the present invention it is also preferred, that the atomization step is carried out as an ultrahigh pressure liquid atomization by jetting at least one liquid with a pressure of at least 300 bar, preferably of at least 600 bar onto the stream of the molten iron-based alloy powder.

Even more preferably, the liquid contains water, preferably the liquid is water, and/or the ultrahigh pressure liquid atomization is carried out by an atomization process comprising at least two stages,

preferably, within a first stage of this atomization process, a stream of the molten iron-based alloy powder is fed through a nozzle into a first area located between the nozzle and a choke and a gas stream, which is preferably a nitrogen-containing gas stream and/or an inert gas stream, circulates around the molten iron-based alloy powder within this first area and, within a second stage of this atomization process, the stream of the molten iron-based alloy powder is fed to a second area located beyond the choke, where the stream of the molten iron-based alloy powder is contacted with a water-containing jet stream under a pressure of at least 300 bar, preferably of at least 600 bar causing a break up and solidification of the stream of the molten iron-based alloy powder into the respective particles, wherein at least 40% of the total amount of the particles have a non-spherical shape.

However, in another embodiment, it is also possible that within a first stage of this atomization process, instead of a stream of the molten iron-based alloy powder, a stream of respective molten iron-based alloy coins, bars and/or discs, is fed through a nozzle into a first area located between the nozzle and a choke and a gas stream circulates around the molten iron-based alloy coins, bars and/or discs within this first area.

Another subject matter of the present invention is a process for producing an iron-based alloy powder as described above. Processes for producing iron-based alloy powders or such are known to a person skilled in the art.

Furthermore, a person skilled in the art knows suitable measures in order to separate particles having a non-spherical shape from particles having a spherical shape. This can be done, for example, by sieving.

Preferably, the process for producing the above-described iron-based alloy powders can be carried out by a method, wherein the iron-based alloy powder is provided in a molten state and an atomization step is carried out with a stream of the molten iron-based alloy powder.

It is preferred, that the atomization step is carried out as an ultrahigh pressure liquid atomization by jetting at least one liquid with a pressure of at least 300 bar, preferably of at least 600 bar onto the stream of the molten iron-based alloy powder.

Even more preferably, the liquid contains water, preferably the liquid is water, and/or the ultrahigh pressure liquid atomization is carried out by an atomization process comprising at least two stages,

preferably, within a first stage of this atomization process, a stream of the molten iron-based alloy powder is fed through a nozzle into a first area located between the nozzle and a choke and a gas stream, which is preferably a nitrogen-containing gas stream and/or an inert gas stream, circulates around the molten iron-based alloy powder within this first area and, within a second stage of this atomization process, the stream of the molten iron-based alloy powder is fed to a second area located beyond the choke, where the stream of the molten iron-based alloy powder is contacted with a water-containing jet stream under a pressure of at least 300 bar, preferably of at least 600 bar causing a break up and solidification of the stream of the molten iron-based alloy powder into the respective particles, wherein at least 40% of the total amount of the particles have a non-spherical shape.

Another subject matter according to the present invention is the use of the at least one iron-based alloy powder as described above within a three-dimensional (3D) printing process and/or in a process for producing a three-dimensional (3D) object.

Three-dimensional (3D) printing process is as such as well as three-dimensional (3D) objects as such are known to a person skilled in the art. Preferably, the at least one iron-based alloy powders according to the present invention are employed within a 3D-printing process in connection of a laser beam or an electron beam technique. It is particularly preferred, that the iron-based alloy powders according to the present invention are employed of in a selective laser melting (SLM) process. As SLM-process as well as other laser beam or electron beam based 3D-printing techniques are known to a person skilled in the art.

Another subject matter according to the present invention is a process for producing a three-dimensional (3D) object wherein the 3D object is formed layer by layer and within each layer at least one iron-based alloy powder as described above is employed.

Within this process it is preferred that in each layer the employed at least one iron-based alloy powder is molten by applying energy on the surface of the iron-based alloy powder,

preferably the energy is applied by a laser beam or an electron beam, more preferably by a laser beam.

It is even more preferred, that the inventive process is carried out as a SLM process as described for example in WO 2019/025471.

Therefore, a process is preferred, wherein the 3D object is produced by a selective laser melting (SLM) process,

preferably the selective laser melting (SLM) process comprises the steps (i) to (iv):
(i) applying a first layer of at least one iron-based alloy powder onto a surface,
(ii) scanning the first layer of the at least one iron-based alloy powder with a focused laser beam at a temperature sufficient to melt at least part of the first layer of the at least one iron-based alloy powder throughout its layer thickness to obtain a first molten layer,
(iii) solidifying the first molten layer obtained in step (ii),
(iv)) repeating process steps (i), (ii) and (iii) with a pattern of scanning effective to form the respective 3D object or at least a part thereof.

Another subject matter of the present invention is a three-dimensional (3D) object as such obtainable by a process according to the present invention as described above by employing at least one iron-based alloy powder according to the present invention as described above.

A further subject matter of the present invention is a three-dimensional (3D) printed object obtained from an iron-based alloy powder according to the present invention.

The invention is explained in more detail below by examples, but is not restricted thereto.

### EXAMPLES

### Inventive Example E1

Production of the Iron-Based Alloy Powder Containing Non-Spherical Particles

An iron-based alloy powder containing non-spherical particles was produced by providing an iron-based alloy powder with the composition listed in table 1 in a molten state and by carrying out an atomization step with a stream of the molten iron-based alloy powder.

TABLE 1

| | Fe | Cr | Mo | Ni | Si | C |
|---|---|---|---|---|---|---|
| Example | [wt. %] | [wt. %] | [wt. %] | [wt. %] | [wt. %] | [wt. %] |
| E1 | 85.53 | 11.0 | 1.0 | 1.7 | 0.6 | 0.17 |

The atomization step was carried out as an ultrahigh pressure liquid atomization by jetting water with a pressure of 600 bar onto the stream of the molten iron-based alloy powder.

The obtained iron-based alloy powder contained roundish to irregularly shaped particles, wherein a cut, comprising particles having a diameter in the range of 15 to 53 microns, was characterized by the following methods:

Particle Size Distribution

To determine the particle size distribution, reported as the d10, d50 and d90 values, the obtained iron-based alloy powder was analysed in dry form. The d10, d50 and d90 values were determined by laser diffraction using a Malvern Master Sizer 2000.

Sphericity Measurements

The proportion of non-spherical particles was optically determined by a particle characterizing system (Camsizer®). It is defined as the proportion of particles whose sphericity is not more than 0.9, based on volume (Q3(SPHT)). The sphericity (SPHT) was determined according to ISO 9276-6, wherein the sphericity (SPHT) is defined by formula (I).

Bulk Density, Tapped Density, Hausner Factor

In addition, the bulk density according to DIN EN ISO 60 and the tapped density according to DIN EN ISO 787-11 were determined. The Hausner factor is the ratio of tapped density to bulk density.

The results of the above-mentioned characterizations can be taken from table 2.

TABLE 2

| | | | | | | | Proportion |
|---|---|---|---|---|---|---|---|
| | | | | | | | of non- |
| | Bulk | Tamped | | | | | spherical |
| | density | density | Hausner | d10 | d50 | d90 | particles |
| Example | [g/cm³] | [g/cm³] | factor | [μm] | [μm] | [μm] | [%] |
| E1 | 3.33 | 3.95 | 1.19 | 17 | 33 | 66 | 50-60 |

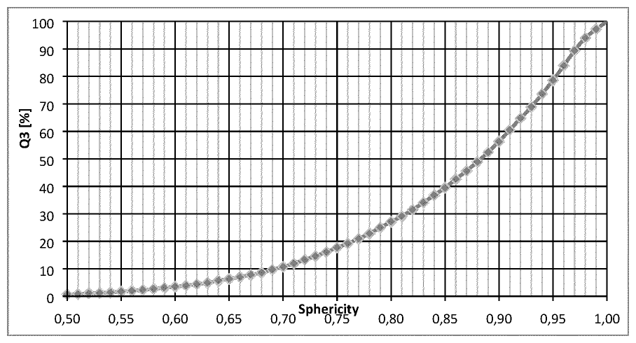

As can be seen from table 2, due to the rather broad particle size distribution, the bulk density of the iron-based alloy powder is improved/higher compared to particles according to the prior art, resulting in a reduced Hausener factor. As further can be seen from table 2 and FIG. 1, at least 50 to 60% of the total amount of particles have a non-spherical shape, which means that they have a sphericity not more than 0.9.

In order to proof the processability of the inventive iron-based alloy powder containing non-spherical particles in a 3D-printing process technique, the inventive powder was tested in a powder bed fusion printer.

Powder Bed Fusion Printer Experiments

The inventive iron-based alloy powder was introduced with a layer thickness of 30 μm into the cavity at the temperature specified in table 3. The iron-based alloy powder was subsequently exposed to a laser with the laser power output specified in table 3 and the hatch distance specified, with a speed of the laser over the sample during exposure of 500 to 550 mm/s. Powder bed fusion printing typically involves scanning in stripes. The hatch distance gives the distance between the centres of the stripes, i.e. between the two centres of the laser beam for two stripes.

TABLE 3

| | Temperature | Laser power | Laser speed | Hatch |
|---|---|---|---|---|
| Example | [° C.] | output [W] | [mm/s] | distance [mm] |
| E1 | 200 | 150-350 | 500-550 | 0.15 |

Subsequently, the properties of the 3D-printed objects obtained were determined. The 3D-printed objects obtained were tested in the dry state. In addition, Charpy bars were produced, which were likewise tested in dry form.

Tensile strength, yield strength and elongation at break were determined according to DIN EN ISO 6892-1.

Hardness (HV) was tested according to DIN EN ISO 6507-4.

The mechanical properties of the 3D-printed objects were determined before (E1a) and after a heat treatment (E1b). For heat treatment, the 3D-printed objects were heated up to 550° C. with a heating rate of 4° C./min under nitrogen atmosphere and kept at 550° C. for 1 h.

The results are given in table 4. The errors are based on standard deviation.

TABLE 4

| | | Charpy | | | |
|---|---|---|---|---|---|
| | | Impact | Tensile | Elongation | Yield |
| | Hardness | Energy | Strength | at Break | strength |
| Example | (HV) | [J] | [MPa] | [%] | [MPa] |
| E1a | 490 (±5) | 17 (±4) | 1670 (±10) | 10 (±3) | 800 (±20) |
| E1b | 400 (±5) | 54 (±4) | 1250 (±10) | 15 (±3) | 1070 (±20) |

As can be seen from table 2, the 3D-printed objects comprising the inventive iron-based alloy are characterized by high strength, hardness and ductility at the same time.

1.-11. (canceled)

12. An iron-based alloy powder containing non-spherical particles wherein the alloy comprises the elements Fe, Cr and Mo, and at least 40% of the total amount of particles have a non-spherical shape, wherein Cr is present at 10.0 wt. % to 18.3 wt. %, Mo is present at 0.5 wt. % to 2.5 wt. %, C is present at 0 to 0.30 wt. %, Ni is present at 0 to 4.0 wt. %, Cu is present at 0 to 4.0 wt. %, Nb is present at 0 to 0.7 wt. %, Si is present at 0 to 0.7 wt. % and N is present at 0 to 0.20 wt. %, the balance up to 100 wt. % is Fe, wherein the sphericity of the particles having a non-spherical shape is not more than 0.9.

13. The iron-based alloy powder according to claim 12, wherein
(i) at least 50%, of the total amount of particles have a non-spherical shape, or
(ii) the total amount of particles having a non-spherical shape is in the range of at least 40 to 70%,.

14. The iron-based alloy powder according to claim 12, wherein
(i) at least 70% of the total amount of particles have a non-spherical shape, or
(ii) the total amount of particles having a non-spherical shape is in the range of 45 to 60%

15. The iron-based alloy powder according to claim 12, wherein
(i) at least 95% of the total amount of particles have a non-spherical shape, or
(ii) the total amount of particles having a non-spherical shape is in the range of 50 to 55%

16. The iron-based alloy powder according to claim 12, wherein
(i) at least 99% of the total amount of particles have a non-spherical shape, or
(ii) the total amount of particles having a non-spherical shape is in the range of 50 to 55%.

17. The iron-based alloy powder according to claim 12, wherein the particles have a diameter in the range of 1 to 200 microns.

18. The iron-based alloy powder according to claim 12, wherein the particles have a diameter in the range of 3 to 70 microns.

19. The iron-based alloy powder according to claim 12, wherein the particles have a diameter in the range of 15 to 53 microns.

20. A process for producing an iron-based alloy powder according to claim 12, wherein the iron-based alloy powder is provided in a molten state and an atomization step is carried out with a stream of the molten iron-based alloy powder.

21. The process according to claim 20, wherein the atomization step is carried out as an ultrahigh pressure liquid atomization by jetting at least one liquid with a pressure of at least 300 bar.

22. The process according to claim 20, wherein the atomization step is carried out as an ultrahigh pressure liquid atomization by jetting at least one liquid with a pressure of at least 600 bar onto the stream of the molten iron-based alloy powder.

23. The process according to claim 20, wherein the liquid contains water, and/or the ultrahigh pressure liquid atomization is carried out by an atomization process comprising at least two stages,
preferably, within a first stage of this atomization process, a stream of the molten iron-based alloy powder is fed through a nozzle into a first area located between the nozzle and a choke and a gas stream, which is preferably a nitrogen-containing gas stream and/or an inert gas stream, circulates around the molten iron-based alloy powder within this first area and, within a second stage of this atomization process, the stream of the molten iron-based alloy powder is fed to a second area located beyond the choke, where the stream of the molten iron-based alloy powder is contacted with a water-containing jet stream under a pressure of at least 300 bar, causing a break up and solidification of the stream of the molten iron-based alloy powder into the respective particles, wherein at least 50% of the total amount of the particles have a non-spherical shape.

24. The process according to claim 23, wherein the liquid is water, and the water-containing jet stream is under a pressure of at least 600 bar.

25. A use of at least one iron-based alloy powder according to claim 12 within a three-dimensional (3D) printing process.

26. A process for producing a three-dimensional (3D) object wherein the 3D object is formed layer by layer and within each layer at least one iron-based alloy powder according to claim 12 is employed.

27. The process according to claim 26, wherein in each layer the employed at least one iron-based alloy powder is molten by applying energy on the surface of the iron-based alloy powder with a laser beam,

28. The process according to claim 26, wherein in each layer the employed at least one iron-based alloy powder is molten by applying energy on the surface of the iron-based alloy powder with an electron beam.

29. The process according to claim 19, wherein the 3D object is produced by a selective laser melting (SLM) process,
preferably the selective laser melting (SLM) process comprises the steps (i) to (iv):
(i) applying a first layer of at least one iron-based alloy powder onto a surface,
(ii) scanning the first layer of the at least one iron-based alloy powder with a focused laser beam at a temperature sufficient to melt at least part of the first layer of the at least one iron-based alloy powder throughout its layer thickness to obtain a first molten layer,
(iii) solidifying the first molten layer obtained in step (ii),
(iv) repeating process steps (i), (ii) and (iii) with a pattern of scanning effective to form the respective 3D object or at least a part thereof.

30. A three-dimensional (3D) object obtainable by a process according to claim 19.
